(19) United States
(12) Patent Application Publication
(10) Pub. No.: US 2018/0111497 A1
(43) Pub. Date: Apr. 26, 2018

(54) POWER ALLOCATION METHOD AND SYSTEM FOR AN ELECTRIC VEHICLE

(71) Applicant: NIO NEXTEV LIMITED, Hong Kong (CN)

(72) Inventors: Junhua LI, Shanghai (CN); Bin HE, Shanghai (CN); Jianyong ZHANG, Shanghai (CN)

(21) Appl. No.: 15/789,490

(22) Filed: Oct. 20, 2017

(30) Foreign Application Priority Data
Oct. 21, 2016 (CN) 201610917442.1

(51) Int. Cl. B60L 11/18

(52) U.S. Cl. CPC B60L 11/1861; B60L 2210/10; B60L 2240/547; B60L 11/1859

(57) ABSTRACT

The present invention provides a power allocation method for an electric vehicle, which comprises: obtaining parameters for estimation from a power management system of the vehicle; b) estimating an available discharge power of the battery based on the obtained parameters for estimation; c) based on the available discharge power and power demands from a plurality of electric power demanding components of the vehicle, determining the power to be allocated for each of the plurality of power demanding components; d) outputting the allocated power to the electric power demanding components, and in the case the power is required to be converted into a torque, converting the allocated power into a torque and outputting the torque. A power allocation system is also provided.

### CROSS-REFERENCE TO RELATED APPLICATIONS

This application claims the benefit of China Patent Application No. 201610917442.1 filed Oct. 21, 2016, the entire contents of which are incorporated herein by reference.

### FIELD OF INVENTION

The present invention relates to the battery management of electric vehicles, and more particularly, to a battery management and a battery power allocation technology for electric vehicles.

### BACKGROUND

Electric cars have effectively solved the problem of sustainable development of the energy and environment. The battery is a primary energy storage system of an electric car, the cost of which is also a major constituent of the cost of an electric car, meanwhile, the development of batteries constrains the development of electric cars.

More particularly, a main reason for the high cost of batteries is because the current service life of automotive batteries is relatively short, whereas the overcharge and over-discharge are main factors that affects the service time of batteries.

### SUMMARY OF INVENTION

To the end, the present invention provides a power allocation method for an electric vehicle, which comprises: a) acquiring parameters for estimation from a battery management system of the vehicle; b) estimating an available discharge power of a battery based on the acquired parameters for estimation; c) based on the available discharge power and power demands from a plurality of electric power demanding components of the vehicle, determining a power allocated for each of the electric power demanding components; d) outputting the allocated power to the electric power demanding components, and in the case that power is required to be converted into torque, converting the allocated power into a torque and outputting the torque.

According to the power allocation method for an electric vehicle, preferably, the parameters for estimation comprise the limited value of a short-term discharge power of a battery and the value of a current discharge power of a battery.

According to the power allocation method for an electric vehicle, preferably, the step b comprises: comparing the value of current discharge power of the battery with the limited value of the short-term discharge power of the battery, and calculating a difference therebetween; using an absolute value of the difference as a reference for adjusting a step size, in the case that the value of a real-time discharge power of the battery is less than the limited value of the short-term discharge power of the battery, setting the estimated available discharge power to be the sum of the real-time discharge power of the battery and the adjusted step size; in the case that the real-time discharge power of the battery is greater than the limited value of the short-term discharge power of the battery, setting the estimated available discharge power to be the difference between the limited value of the short-term discharge power of the battery and the step size.

According to the power allocation method for an electric vehicle, preferably, the step c comprises: for the electric power demanding components, setting up a priority table for power allocation; in the case that the available discharge power satisfies the current power demands from the electric power demanding components of the electric vehicle, allocating power for them as needed; in the case that the available discharge power does not satisfy the current power demands from the electric power demanding components of the electric vehicle, allocating power based on the priority table.

According to the power allocation method for an electric vehicle, preferably, the parameters for estimation further comprise the limited value of a short-term charge power of a battery and a current charge power of a battery, the method comprises: estimating an available charge power of the battery, based on the limited value of the short-term charge power of the battery and the current charge power of a battery; acquiring a charge power for the electric power recycled during the operation of the vehicle; comparing the estimated available charge power with the charge power of the recycled electric power, and in the case that the available charge power is less than the charge power of the recycled electric power, performing processing for anti-overcharge.

According to the power allocation method for an electric vehicle, as a non-limitative example, the electric vehicle is an electric car.

According to another aspect of the invention, a power allocation system for an electric vehicle is also provided, which comprises: a first estimation module, being coupled to a battery management system of the vehicle to acquire parameters for estimation therefrom, and estimating an available discharge power of the battery based on the acquired parameters for estimation, wherein, the parameters for estimation comprise the limited value of a short-term discharge power of the battery and the value of the current discharge power of the battery; and a power allocation module, determining a power to be allocated for each of the plurality of power demanding components based on the available discharge power acquired from the first estimation module and power demands from the plurality of electric power demanding components of the vehicle, and outputting the allocated power; a torque calculation module, being coupled to the power allocation module, the torque calculation module is used for converting a driving power into a torque value after obtaining the driving power allocated to an electric motor control system and generated by the power allocation module, such that the torque is transmitted to the electric motor control system.

According to the power allocation system for an electric vehicle of the invention, as an example, the first estimation module may be configured to: compare the value of current discharge power of the battery with the limited value of the short-term discharge power of the battery, and calculate a difference therebetween; and use an absolute value of the difference as a reference for adjusting a step size, in the case that the value of a real-time discharge power of the battery is less than the limited value of the short-term discharge power of the battery, setting the estimated available discharge power to be the sum of the real-time discharge power of the battery and the adjusted step size; in the case that the real-time discharge power of the battery is greater than the limited value of the short-term discharge power of the battery, setting the estimated available discharge power to be the difference between the limited value of the short-term discharge power of the battery and the step size. Further, exemplarily, the first estimation module may be configured to comprise a first unit, for comparing the value of current discharge power of the battery with the limited value of the short-term discharge power of the battery, and calculating the difference therebetween; and a second unit, for using an absolute value of the difference as a reference for adjusting the step size, and in the case that the real-time discharge power of the battery is less than the limited value of the short-term discharge power of the battery, setting the estimated available discharge power to be the sum of the real-time discharge power of the battery and the adjusted step size, and in the case that the real-time discharge power of the battery is greater than the limited value of the short-term discharge power of the battery, setting the estimated available discharge power to be the difference between the limited value of the short-term discharge power of the battery and the step size.

The power allocation system for electric vehicles illustrated according to the invention, preferably, further comprises a second estimation module, which is configured to collect operations of a driver, and estimating power demands from a driving system based on the operations of the driver.

The power allocation system for electric vehicles illustrated according to the invention, preferably, the power allocation system also comprises a preset priority table for power allocation, and the power allocation module is configured to: in the case that the available discharge power satisfies the current power demands from electric power demanding components of the vehicle, determining a power to be allocated for them as needed; in the case that the available discharge power does not satisfy the current power demands from electric power demanding components of the vehicle, determining the allocated power based on the priority table.

### BRIEF DESCRIPTION OF DRAWINGS

FIG. 1 is a flowchart of a power allocation method for an electric vehicle illustrated according to the invention, wherein, as an example, the electric vehicle is an electric car.

FIG. 2 is an illustrative graph for estimating an available discharge power.

FIG. 3 is a diagram of the principle of a self-learning algorithm for the ultralimit of a discharge power of a battery.

FIG. 4 is a flowchart of an exemplary power allocation method according to the invention.

FIG. 5 is a structure diagram of the power allocation system for an electric vehicle illustrated according to the invention.

### DESCRIPTION OF EMBODIMENTS

Now the illustrative examples of the invention are described in reference to the appended drawings, wherein like numerals in the drawings denote like elements. The examples described hereinafter facilitate one of ordinary skill in the art to comprehend the present invention thoroughly, which are intended to be exemplary rather than limiting. The illustrations of each of the elements, components, modules, devices or the apparatus itself in the drawings are not drawn to scale, and merely illustratively represent the relative relationships between these elements, components, modules, devices as well as the apparatus itself.

In the following examples, an electric car regarded as a vehicle is used to set forth the power allocation method and system for an electric vehicle according to the invention, however, this does not intend to limit the power allocation method and system illustrated according to the invention merely to an electric car, a variety of other vehicles which utilize a battery for providing power may also use the power allocation method and system according to the invention. Furthermore, the battery referred herein which requires a prevention of overcharge and/or over-discharge mainly refer to a power battery of an electric car, rather than a small battery which is used for supplying power to some instruments in an electric car.

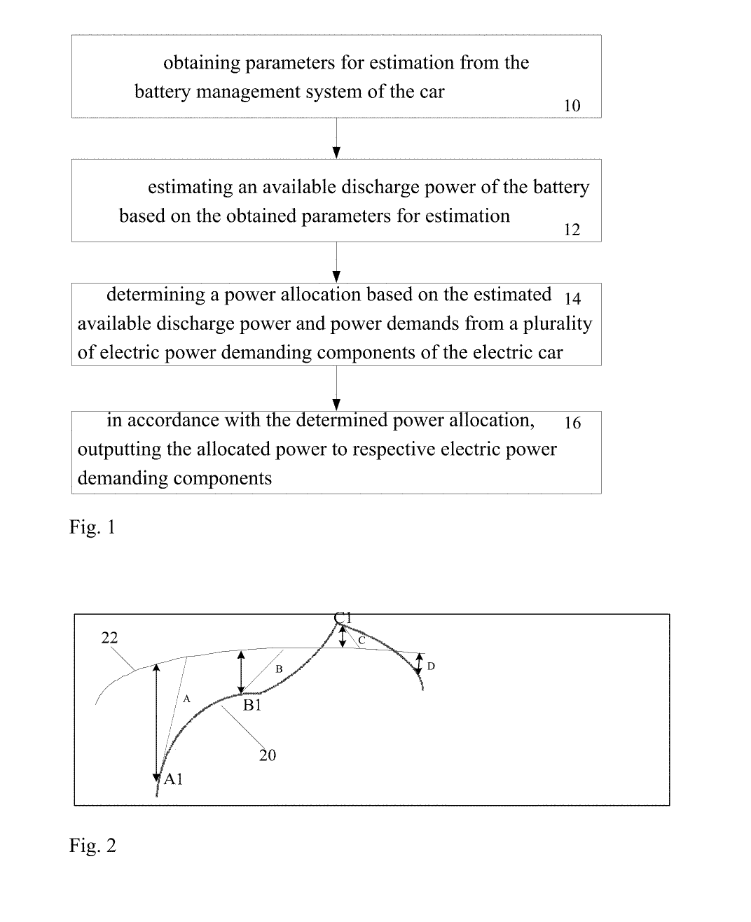

FIG. 1 is a flowchart of a power allocation method for an electric vehicle illustrated according to the invention, wherein, as an example, the electric vehicle is an electric car. As showed in FIG. 1, in step 10, parameters for estimation are acquired from a battery management system of a car. According to the invention, parameters for estimation comprise a limited value of a short-term power of the battery and a current discharge power of the battery which are used for estimating the discharge power.

In step 12, an available discharge power of the battery is estimated based on the acquired parameters for estimation.

FIG. 2 is an illustrative graph of the estimated available discharge power. As showed in FIG. 2, a curve 20 represents a current discharge power of the battery output by a battery management system, a curve 22 represents a limited value of a short-term discharge power of the battery output by the battery management system. The absolute value of the difference, P_{difference}, in the vertical direction of curve 20 and curve 22 (the vertical direction is the value of power, and the horizontal direction is timeline), namely, their difference at the same point of time, is used as a reference for adjusting the step size, Step.

The estimated discharge power P_{—ESdischarge} is the current discharge power of the battery P_{current}±Step represented by curve 20. Wherein, in the case that the limited value of the short-term discharge power of the battery is greater than the current discharge power of the battery, the estimated discharge power P_{—ESdischarge} is P_{current}+Step, in the case that the limited value of the short-term discharge power of the battery is less than the current discharge power of the battery, the estimated discharge power P_{—ESchscharge} is P_{current}−Step.

Exemplarily, at the point A1 showed in FIG. 2, the current discharge power of the battery P_{A1}_{_}_{current} is less than the limited value of the short-term discharge power of the battery P_{A1}_{_}ₗᵢₘᵢₜ, so the estimation module 10 estimates based on the difference value P_{A1}_{_}_{difference} at the point of time, the estimated power of the battery is P_{A1}_{_}_{current}+Step_A1, wherein, Step_A1 represents an adjusted step size based on point A1. For point B1, its estimating manner is the same as point A1. For point C1, since the current discharge power P_{C1}_{_}_{current} exceeds the limited value of the discharge power of the battery, therefore, the estimated power value of the battery for point C1 is P_{C1}_{_}_{current}-Step_C1, wherein, Step_C1 represents an adjusted step size based on point C1. In brief, when estimating the available discharge power, it is intended to enable the available discharge power of the battery to approach to the limited value of the short-term discharge power as closed as possible, so as to utmostly make use of the function of the battery.

Further, according to an example of the invention, a step size adjustment table may be preset, the step size required for adjustment which corresponds to various difference value P_{difference} is given in the table. For example, table 1 is an exemplary step size adjustment table which gives the step sizes required to be adjusted corresponding to various difference value,

TABLE 1

| P_{difference} | 2 | 5 | 10 | 100 | 300 | 450 |
|---|---|---|---|---|---|---|
| Step in an ascent | 0 | 200 | 500 | 800 | 1000 | 2000 |
| phase (e.g. point A1, B1) | | | | | | |

Herein, it should be noted that, if the difference between the determined limited value of short-term discharge power of the battery and the current discharge power of the battery is not listed in the given step size adjustment table, then find two approximate values from the table to perform an interpolation operation and obtain the respective step size of adjustment, based on which adjustment can be achieved.

For example, assuming the difference between the determined limited value of the short-term discharge power of the battery and the current discharge power of the battery is 7, then find two sets of difference value that are most approximate, that is, the two sets of data 5 and 10, so that, for example, the step size corresponding to 7 is determined according to the ratio of 7 in between 5 and 10, which is showed as equation 1:

$$Step corresponding to the difference value of 7 = 200 + \frac{7 - 5}{10 - 5} \times ( 500 - 200 ) \qquad ( 1 )$$

Table 2 gives the case that the current power of the battery is less than the limited value of the short-term discharge power of the battery. The step size Step to be adjusted is determined, according to the setting of difference value P_{difference} between curve 22 and curve 20 in table 2, so that an available discharge power is determined.

TABLE 2

| P_{difference} | 10 | 50 | 100 |
|---|---|---|---|
| Step in an ultralimit phase (e.g. point C1) | −500 | −800 | −1500 |

Furthermore, according to some examples of the invention, when estimating the available discharge power, a battery temperature, and a limited value of a long-term discharge power of a battery may also be considered, so as to correct the determined step size. Generally, in the case that the battery temperature is relatively high or relatively low, the available discharge power is lowered. In the case that the difference between the limited value of the long-term discharge power of the battery and the limited value of the short-term discharge power of the battery is relatively high, then the step size may be moderately increased.

When the limited value of the short-term discharge power of the battery output by the battery management system is decreased, if the estimated discharge power is greater than the limited value of the discharge power of the battery put by the battery management system, then the estimated discharge power is adjusted to the limited value or to less than the limited value. Accordingly, in the case that the short-term discharge power from the battery management system is restored, the discharge power is re-estimated, so as to fully make use of the ability of the battery.

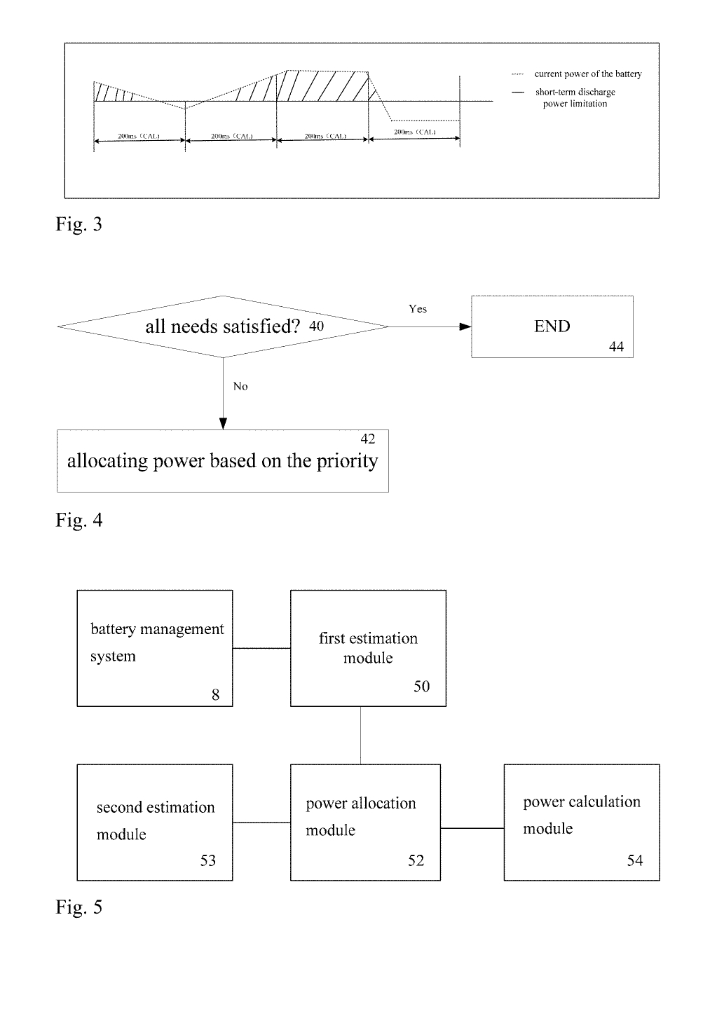

According to some other examples of the invention, the ultralimit situation of the entire life cycle of the battery pack may further be recorded with a self-learning algorithm, that is, the situation of the discharge power of the battery exceeding the limited value of the short-term discharge power of the battery, and the discharge ability of the battery is limited according to the number of times of ultralimit. FIG. 3 is a diagram of the principle of a self-learning algorithm for the ultralimit of a discharge power of a battery. As showed in FIG. 3, the current discharge power of the battery is monitored in real-time, if the current discharge power of the battery exceeds the limitation, then the excess power may be integrated, if the integration reaches a set upper limit during a period of time, then the ultralimit situation will be stored, and the limited value of the available discharge power of the battery is automatically corrected.

Referring back to FIG. 1, in step 14, the power allocation is determined based on the estimated available discharge power and the power demands from a plurality of electric power demanding components of the electric car.

More particularly, a priority table for power allocation is set up in advance for the electric power demanding components. In the table, the order of electric power demanding components which should be considered preferably in the power allocation is listed. The setting up of the priority for power allocation may be set up according to actual needs, but usually, the power demands for guaranteeing the safe driving of the vehicle has a high priority. For example, the demands for the driving power required for driving a car by a diver, the demands for defrosting and defogging, etc. generally has a high priority. In the case that the estimated available discharge power is able to satisfy the summation of the power demands from the electric power demanding components which currently need electric power, the power is allocated for them as needed. However, in the case that the estimated available discharge power is not able to satisfy the power demands from all electric power demanding components which currently need electric power, then the power is allocated according to the priority table.

FIG. 4 is a flowchart of an exemplary power allocation method according to the invention. According to the method, in step 40, first judge whether the estimated available discharge power of the battery satisfies the power demands from all electric power demanding components which currently need electric power. In the example, the current power demands comprise a power demands from the driving system which is estimated according to the driving operation of the driver, a power demands for defrosting and defogging, a power required for a high voltage to low voltage converter, a power required for a vehicle to enter a sport mode, and a power required for the air conditioner to operate. If the judging result of step 40 is that the estimated available discharge power of the battery satisfies all of the above current power demands, then proceeds to step 44, end. If the judging result of step 40 is that the estimated available discharge power of the battery fail to satisfy the summation of the above power demands, or in another word, fail to satisfy all of the above power demands, then proceed to step 42, allocating power according to the priority set in the priority table. In the example, the request for defrosting and defogging is preferably satisfied, a power is allocated for the defrosting and defogging component, thus the safety of vehicle driving is guaranteed, then the high voltage to low voltage converting power is adjusted according to the power level condition of the small battery, so as to guarantee the normal electricity demands from automotive appliances, and then further satisfy a power demands from the driving system which is estimated according to the driving operation of the driver. Wherein, the power demands for the driving system is estimated according to the input of the driver, such as an accelerator, a break and a related status of an electric motor. If the external temperature is too high or too low, the power required for an air conditioner to operate is satisfied, to provide a more comfortable driving environment.

Referring back to FIG. 1, in step 16, the allocated power is output to the respective electric power demanding components, according to the determined power allocation, and in the case of requiring to convert the power into a torque, the allocated power is converted into torque before being output. Usually, the power allocated to an electric motor control system, namely, the power of the driving system which is estimated according to the driving operation, is output to the MCU of the electric motor control system after being converted into torque.

According to some other examples of the invention, the parameters for estimation obtained from the power management system further comprise a limited value of a short-term charge power of a battery and a current charge power of a battery. Herein, the charge power refers to a charge power at the time the electric power recycled during a vehicle driving is charging the power battery of the vehicle. An available charge power of a battery is estimated, based on the limited value of the short-term charge power of the battery and the current charge power of the battery. The charge power provided by the recycled electric power in the electric car is acquired. The estimated available charge power of the battery is compared to the charge power of the recycled electric power, and in the case that the available charge power is less than the charge power of the recycled electric power, a process of overcharge prevention is performed. Actually, the estimated available charge power of the battery is equivalent to the allowed charge power of the battery.

As an example, the process of overcharge prevention is to decrease the electric power generating ability of an electric power regenerating system of the vehicle. For instance, the electric power regenerated by the electric motor may satisfy the electric power demands for a high voltage device in the vehicle to operate, such as an air conditioner, etc., there may still be a residual power to charge the power battery of the vehicle, at the time, if the allowed charge power of the power battery (i.e., the estimated available charge power) is less than the charge power that may be provided to the power battery from the electric power regenerated by the electric motor, then a request for decreasing the breaking torque regenerated by the electric motor is generated, so as to control the electric motor to enable it to decrease the generation of a regenerated breaking force. According to the invention, a high voltage device comprises an air conditioner, and a high voltage to low voltage converter (also referred to as a DCDC converter), etc.

Wherein, the process of estimating the available charge power of the battery based on the limited value of the short-term charge power and the current charge power of the battery is similar to the method for estimating the available discharge power introduced in detail in the above, which intend to adjust the available charge power of the battery by determining a step size.

FIG. 5 is a structure diagram of the power allocation system for an electric vehicle illustrated according to the invention. As showed in the figure, the power allocation system comprises a first estimation module 50, a power allocation module 52, and a power calculation module 54.

The first estimation module 50 is electrically connected with an existing battery management system 8, and acquires parameters for estimation from it. According to the invention, the parameters for estimation comprise a limited value of a short-term power of the battery which is used for estimating the discharge power, and a current discharge power of a battery. The first estimation module 50 estimates an available discharge power of a battery based on the acquired limited value of the short-term power of the battery and the current discharge power of the battery. The process of estimation is in accordance with the above step 12 in conjunction with FIG. 1 as well as in accordance with FIG. 2, FIG. 3.

A power allocation module 52 determines the power allocation based on the estimated available discharge power and the power demands from a plurality of electric power demanding components of the electric car. According to the example of the invention, a priority table for power allocation is preset, as mentioned in the above, the order of electric power demanding components which should be considered preferably is listed in the priority table. The power allocation module 52, in the case that the estimated available discharge power is able to satisfy the summation of power demands from the electric power demanding components which currently need electric power, allocates power for them as needed; in the case that the estimated available discharge power is not able to satisfy the power demands from all electric power demanding components which currently need electric power, then the power is allocated according to the priority table.

According to one example of the invention, the power allocation system also comprises a second estimation module 53, which is used for collecting the operation of a driver, and estimating the power demands of the driving system based on the operation of the driver. The second estimation module collects the situation of a driver stepping on an accelerator, the situation of a driver stepping on a break, and the related status of an electric motor, and thus estimates the power demands from the driving system, namely, the power performance demands of a driver.

The power allocation module 52 is electrically connected to the defrosting and defogging component (or system) of the vehicle to learn whether there is a request for defrosting or defogging, electrically connected to the external temperature sensor to learn the temperature inside the car, electrically connected to the vehicle mode selection system to learn the mode selection request of the driver (for example, whether the driver has chosen a sport mode, etc.), electrically connected to the small battery of the vehicle to learn its power level condition, electrically connected to the air conditioner control system of the vehicle to learn the energy it consumes and transfer the allocated power to it while the air conditioner is operating, and electrically connected to the high voltage to low voltage converter of the vehicle to learn the power it consumes and transfer the allocated power to it.

The power allocation module 52 is electrically connected to the power calculation module 54, before the power allocation module 52 transfers the power allocated for the driving system to the MCU of the electric motor control system, the allocated power is first converted in to torque by the power calculation module 54, and then transferred to the power calculation module 54.

One particular exemplary allocation process of the power allocation module 52 is similar to the process described in conjunction with FIG. 4 in the above. For example, in actual applications, the method described in conjunction with FIG. 4 in the above may be implemented as a software, which is executed by the power allocation module 52.

According to some other examples of the invention, the first estimation module 50 further acquires the limited value of the short-term charge power of the battery and the current charge power of the battery from the battery management system 8. The first estimation module 50 estimates the available charge power of the battery based on the limited value of the short-term charge power of the battery and the current charge power of the battery. The first estimation module 50 further acquires the charge power of the recycled electric power in the electric car. The estimated available charge power of the battery is compared to the charge power of the recycled electric power, and in the case that the available charge power is less than the charge power of the recycled electric power, preforms processing for anti-overcharge. In particular, when the first estimation module 50 is being processed for anti-overcharge, a signal that decreases the ability for power recycle of a high voltage system in the vehicle is generated, and sent to a relevant control component. For example, a signal requesting for reducing the regenerated breaking torque of the electric motor is generated, and sent to the electric motor control system. As an alternation, the first estimation module 50 may also judge whether the current power demands from the electric power demanding components of the car is less than the charge power of the recycled electric power, if so, then reduce the ability of the car for recycling electric power. If the current power of the electric power demanding components of the car is greater than the charge power of recycled electric power, then the first estimation module 50 directly allocates the charge power of recycled electric power to the current electric power demanding component when allocating power for current electric power demanding components, that is to say, the recycled electric power is directly applied to the electric power demanding component.

Although a plurality of examples or embodiments according to the principle of the invention is described in an exemplary way, one of ordinary skill in the art may use one or more of these examples in combination with each other, without departing from the principle and scope of the invention.

1. A power allocation method for an electric vehicle, comprising:
a) acquiring parameters for estimation from a battery management system of the vehicle;
b) estimating an available discharge power of a battery based on the acquired parameters for estimation;
c) based on the available discharge power and power demands from a plurality of electric power demanding components of the vehicle, determining a power to be allocated for each of the electric power demanding components;
d) outputting the allocated power to the electric power demanding components, and in the case that power is required to be converted into torque, converting the allocated power into a torque and outputting the torque.

2. According to the method of claim 1, wherein, the parameters for estimation comprise the limited value of a short-term discharge power of a battery and the value of a current discharge power of the battery.

3. According to the method of claim 4, wherein, the step b comprises:
comparing the value of the current discharge power of the battery to the limited value of the short-term discharge power of the battery, and calculating a difference therebetween;
using an absolute value of the difference as a reference for adjusting a step size, in the case that the value of a real-time discharge power of the battery is less than the limited value of the short-term discharge power of the battery, setting the estimated available discharge power to be the sum of the real-time discharge power of the battery and the adjusted step size;
in the case that the real-time discharge power of the battery is greater than the limited value of the short-term discharge power of the battery, setting the estimated available discharge power to be the difference between the limited value of the short-term discharge power of the battery and the step size.

4. According to the method of claim 1, wherein, the step c comprises:
for the electric power demanding components, setting up a priority table for power allocation;
in the case that the available discharge power satisfies the current power demands from the electric power demanding components of the electric vehicle, allocating power for them as needed;
in the case that the available discharge power does not satisfy the current power demands from the electric power demanding components of the electric vehicle, allocating power based on the priority table.

5. According to the method of claim 4, wherein, the parameters for estimation further comprise the limited value of a short-term charge power of a battery and a current charge power of a battery, the method comprises:
estimating an available charge power of the battery, based on the limited value of the short-term charge power of the battery and the current charge power of the battery;
acquiring a charge power of the electric power recycled during the operation of the vehicle;
comparing the estimated available charge power with the charge power of the recycled electric power, and in the case that the available charge power is less than the charge power of the recycled electric power, preforming processing for anti-overcharge.

6. According to the method of claim 5, wherein, the processing for anti-overcharge comprises:
decreasing the electric power generation ability of a recycled electric power generation system of the vehicle.

7. According to the method of claim 5, wherein, the processing for anti-overcharge comprises:
the high voltage device comprising an air conditioner, and a DCDC converter in the vehicle.

8. According to the method of claim 1, wherein, the electric vehicle is an electric car.

9. A power allocation system for an electric vehicle, which comprises:
a first estimation module, being coupled to a battery management system of the vehicle to acquire parameters for estimation therefrom, and estimating an available discharge power of the battery based on the acquired parameters for estimation, wherein, the parameters for estimation comprise the limited value of a short-term discharge power of the battery and the value of a current discharge power of the battery; and
a power allocation module, determining a power to be allocated for each of the plurality of power demanding components based on the available discharge power acquired from the first estimation module and power demands from the plurality of electric power demanding components of the vehicle, and outputting the allocated power;
a torque calculation module, being coupled to the power allocation module, the torque calculation module is used for converting a driving power into a torque after obtaining the driving power allocated to an electric motor control system and generated by the power allocation module, such that the torque is transmitted to the electric motor control system.

10. According to the power allocation system for an electric vehicle of claim 9, wherein, the estimation module being configured to:
compare the value of current discharge power of the battery with the limited value of the short-term discharge power of the battery, and calculate a difference therebetween; and
use an absolute value of the difference as a reference for adjusting a step size, in the case that the value of a real-time discharge power of the battery is less than the limited value of the short-term discharge power of the battery, setting the estimated available discharge power to be the sum of the real-time discharge power of the battery and the adjusted step size;
in the case that the real-time discharge power of the battery is greater than the limited value of the short-term discharge power of the battery, setting the estimated available discharge power to be the difference between the limited value of the short-term discharge power of the battery and the step size.

11. According to the power allocation system for an electric vehicle of claim 10, wherein, further comprising a second estimation module, which is configured to collect the operation of the driver, and estimate the power demands from the driving system according to the operation of the driver.

12. According to the power allocation system for an electric vehicle of claim 11, wherein, the power allocation system further comprises a preset priority table for power allocation; the power allocation module is configured to:
in the case that the available discharge power satisfies the current power demands from the electric power demanding components of the vehicle, determine the power to be allocated for them as needed;
in the case that the available discharge power does not satisfy the current power demands from the electric power demanding components of the vehicle, determine the power to be allocated based on the priority table.

13. According to the power allocation system for an electric vehicle of claim 9, wherein,
the first estimation module is further configured to acquire the limited value of a short-term charge power of the battery and a current charge power of the battery from the battery management system, and estimate an available charge power of the battery based on the limited value of the short-term charge power of the battery and the current charge power of the battery, acquire a charge power of a recycled electric power during the operation of the vehicle, and compare the estimated available charge power with the charge power of the recycled electric power, and in the case that the available charge power is less than the charge power of the recycled electric power, preforming processing for anti-overcharge.

14. According to the power allocation system for an electric vehicle of claim 9, wherein, the electric vehicle is an electric car.
